(19) United States
(12) Patent Application Publication
(10) Pub. No.: US 2017/0149581 A1
(43) Pub. Date: May 25, 2017

(54) DISPLAY DEVICE COMPRISING A WIRELESS INTERFACE AND AN INTERFACE TO A BUS SYSTEM OF A NETWORKED CONTROL SYSTEM

(71) Applicant: EATON ELECTRICAL IP GMBH & CO. KG, Schoenefeld (DE)

(72) Inventor: Georg REIDT, Swisttal (DE)

(21) Appl. No.: 15/300,280

(22) PCT Filed: Mar. 31, 2015
(86) PCT No.: PCT/EP2015/057065

§ 371 Date: Sep. 29, 2016

(30) Foreign Application Priority Data
Apr. 2, 2014 (DE) 10 2014 104 657.9

(51) Int. Cl. H04L 12/40; G08C 17/02

(52) U.S. Cl. CPC H04L 12/40078; H04L 12/40019; H04L 12/4011; G08C 17/02; H04L 2012/40215; G08C 2201/20; G08C 2201/50

(57) ABSTRACT

A display device has a wireless interface which permits communication between the display device and a device configured for communication with said display device; an interface to a bus system of a networked control system, the display device being configured as a bus slave in said bus system; a multi-color display element for displaying the operating state of at least one station; and a controller configured to control the multi-color display element and to control the communication via the wireless interface and the bus-system interface.

### CROSS-REFERENCE TO RELATED APPLICATIONS

This application is a U.S. national stage application under 35 U.S.C. §371 of International Application No. PCT/EP2015/057065, filed on Mar. 31, 2015, and claims benefit to German Patent Application No. DE 10 2014 104 657.9, filed on Apr. 2, 2014. The International Application was published in German on Oct. 8, 2015, as WO 2015/150402 A1 under PCT Article 21(2).

### FIELD

The invention relates to a display apparatus comprising a wireless interface and an interface to a bus system of a networked control system.

### BACKGROUND

The German Offenlegungsschrift DE 10 2006 009 979 A1 relates to a device for wireless communication with a field device which has an interface for wired communication in an automation network, in particular according to the HART or PROFIBUS PA standard. In order to be able to integrate the field device into the automation network wirelessly too, a radio module is also provided, which converts the wired communication of the field device into wireless communication.

The German Offenlegungsschrift DE 10 2006 017 243 A1 relates to a transceiver for wireless transmission of a field device signal. The transceiver has a radio interface for wireless communication and a field device interface for connection to a field device or for connection to an evaluation device. In the process, the transceiver is designed to convert a field device signal, i.e. a measured value or a control command, between the radio interface and the field device interface.

A field device comprising a display apparatus for on-site presentation of operating states of an automated process is known from the German utility model DE 201 22 094 U1. The display apparatus has a display element of changeable appearance. The display element can have an illuminant of adjustable light color for illuminating a display background and can react to a state indication signal by the illuminant lighting up the display background in a light color that indicates the operating state currently being represented by the state indication signal. A switch apparatus comprising a radio module and a deactivation function is known from the German Offenlegungsschrift DE 10 2012 106 923 A1. Information about the operating state of the switch apparatus can be provided via the radio module in a wirelessly retrievable manner. A display element in the form of a multicolor LED, which can show a color depending on an operating parameter of the switch device, can be provided on the radio module.

### SUMMARY

An aspect of the invention provides a display apparatus, comprising: a wireless interface, which allows communication between the display apparatus and a device configured for communication with the display apparatus; an interface to a bus system of a networked control system, the display apparatus being configured as a bus slave in the bus system; a multicolor display element, configured to display an operating state of at least one station; and a controller, configured to control the multicolor display element and control the communication via the wireless interface and the bus system interface, wherein the controller is configured to receive data from at least one station via a bus of the bus system, and wherein the controller is configured to transmit the data via the wireless interface to the device configured for communication with the display apparatus.

### BRIEF DESCRIPTION OF THE DRAWINGS

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 is a block diagram of a networked control system comprising a display apparatus according to the invention.

### DETAILED DESCRIPTION

An aspect of the present invention provides a display apparatus comprising a wireless interface, which is designed for use in a networked control system.

An aspect of the present invention is based on the idea of additionally equipping a display apparatus comprising a wireless interface with an interface to a bus system of a networked control system and configuring the display apparatus as a bus slave in the bus system. By means of such a display apparatus that is integrated into a networked control system as a station and can be operated by a bus master, a flexible access point to the networked control system can be created by the wireless interface, which access point makes it possible to be able to display the operating state of one or more stations via mobile communication devices in particular, such as a portable computer, tablet PC, mobile telephone, smartphone, PDA (personal digital assistant) or data glasses. While the multicolor display element makes it possible in particular to display very important, binary information from stations without additional technical aids, in particular to visually indicate the critical operating state of a station accordingly, for example by a certain color pattern and/or flashing pattern, the wireless interface allows the provision of additional complex information about stations, primarily also over relatively great distances, in particular the transmission of data corresponding to the critical operating state of a station to a device configured for communication with the display apparatus for analysis and display on the device. Furthermore, commands from the device configured for communication with the display apparatus can be received via the wireless interface, and are processed in the display device, for example in order to configure the multicolor display element, and/or can be transmitted via the bus system interface to a bus master (24) for processing.

In an aspect of the process, a critical operating state can, for example, be a malfunction of a component or if a measured value registered by a sensor is outside specified parameters. A critical operating state can, in particular, also exist if a motor protection switch reports an overload tripping.

An embodiment of the invention relates to a display apparatus comprising a wireless interface, which allows communication between the display apparatus and a device configured for communication with said display apparatus, an interface to a bus system of a networked control system, the display apparatus being configured as a bus slave in the bus system, a multicolor display element for displaying the operating state of at least one station, and a controller configured to control the multicolor display element and to control the communication via the wireless interface and the bus system interface such that a critical operating state of a station is visually indicated accordingly by the multicolor display element and data corresponding to the critical operating state of the station is transmitted via the wireless interface to the device configured for communication with the display apparatus for analysis and display on the device, and commands for configuring the multicolor display element received by the device configured for communication with the display apparatus are processed and/or transmitted via the bus system interface to a bus master (24) for processing. The bus system can in particular be based on the applicant's SmartWire DT® technology, or can be a field bus according to the IEC 61158 standard or can be implemented by an industrial Ethernet.

The controller can be configured to receive data from at least one station via the bus of the bus system and to transmit said data via the wireless interface to a device configured for communication with the display apparatus.

Moreover, the controller can be configured to receive data from a control unit, configured as a bus master, of the networked control system via the bus of the bus system and to transmit said data via the wireless interface to a device configured for communication with the display apparatus.

The display apparatus can have a manual activation element, which is connected to the controller and which, when activated, sets a flag for the controller, which flag can be analyzed by a bus master, and/or carries out a programmed function.

The wireless interface can be a radio module which is integrated in the activation element together with the multicolor display element. The radio module can be configured to transmit data according to a standard such as IEEE 802.15.1 (Bluetooth®, in particular Bluetooth® Low Energy), IEEE 802.11 (wireless local area network—WLAN), ISO 14443, 18092, 21481 ECMA 340, 352, 356, 362, ETSI TS 102 190 (near field communication—NFC).

The display apparatus can in particular be configured as a Modbus® RTU slave or as a CANopen® slave. In the process, the controller can be programmed such that it has data objects which can be described by corresponding programming of the networked control system via the bus system, and such that it transmits the described data objects via the wireless interface to a device configured for communication with the display apparatus.

A further embodiment of the invention relates to a communication device comprising a wireless interface which has a processor that is programmed such that the communication device can communicate via the wireless interface with a display apparatus according to the invention and as described herein, and can receive data from the display apparatus and display it on a screen. These can be communication devices, in particular a portable computer, tablet PC, mobile telephone, smartphone, PDA (personal digital assistant) or data glasses.

Further advantages and possible applications of the present invention will emerge from the following description in conjunction with the embodiments shown in the drawings.

In the following description, elements that are the same, have the same function or are functionally related may be provided with the same reference numerals. Absolute values are only stated below by way of example and are not to be understood to limit the invention.

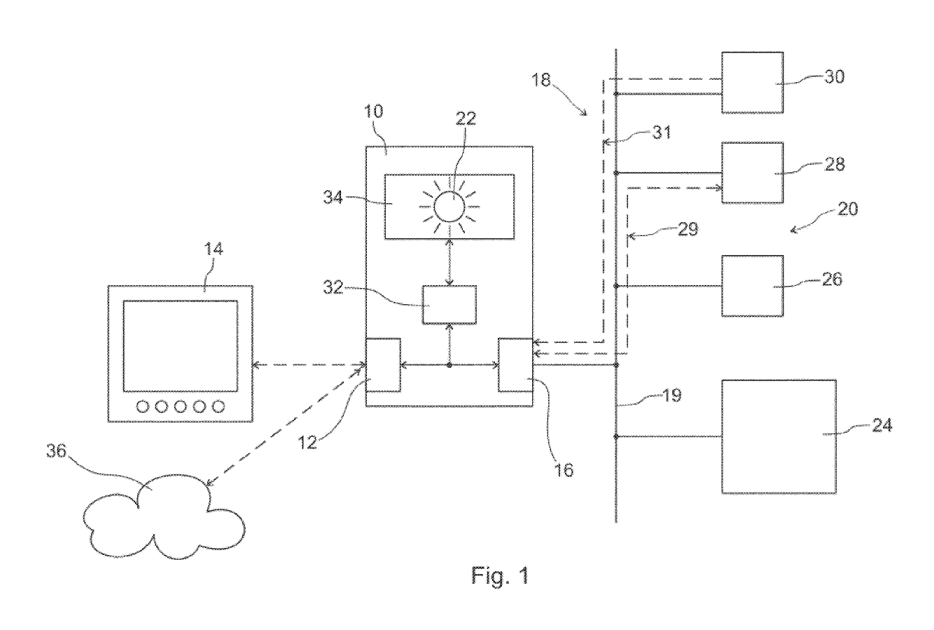

FIG. 1 shows the use of the display apparatus 10 according to the invention in a networked control system 20 for expanding the display options for the operating state of the elements of the networked control system 20.

The display apparatus 10 is implemented as a bus slave station having a multicolor indicator (MCI) in the form of a multicolor light-emitting diode 22. As communication interfaces, the MCI bus slave 10 has a radio module 12 and a wired bus interface 16. Instead of a radio module, a different wireless communication module can also be used, such as an infrared communication module or a module designed to transfer data by means of pulsed light.

The radio module 12 can be set up for data communication according to various radio transmission standards such as IEEE 802.15.1 (Bluetooth®, 20 in particular Bluetooth® Low Energy), IEEE 802.11 (Wireless Local Area Network—WLAN), ISO 14443, 18092, 21481 ECMA 340, 352, 356, 362, ETSI TS 102 190 (Near Field Communication—NFC). Of course, other radio transmission standards are also possible, in particular the manufacturer's own standards or mobile communication standards.

The wired bus interface 16 can in particular be set up for data communication according to the Modbus® or CANopen® standard. Of course, other standards for data communication via buses, in particular field buses, are also possible, for example the manufacturer's own standards.

The data transfer via the radio module 12 and the bus interface 16, and the multicolor light-emitting diode 22 are controlled by a controller 32 of the MCI bus slave 10, which is configured accordingly by firmware set up in a memory of the controller 32.

The color display of the multicolor light-emitting diode 22 serves to indicate important and binary information from elements of the networked control system 20. More complex information, such as measured values, can be transmitted from the MCI bus slave 10 via the radio module 12 by means of data communication to the additional device thereof, such as a tablet PC 14, which likewise has a radio module and is connected via a radio connection, for example a Bluetooth® connection, to the MCI bus slave 10 for data communication. Hereinafter, the tablet PC 14 is mentioned as the communication partner of the MCI bus slave 10, although, of course, the other devices already mentioned at the beginning can be used as the communication partner as well as, in principle, any data processing device having a radio module.

Furthermore, the MCI bus slave 10 has a push button 34, via which, for example, the controller 32 can be activated to carry out certain actions. For example, when the push button 34 is activated, the controller 32 can set a flag which can be analyzed by a bus master of the networked control system 20 and/or the controller can carry out a programmed function upon activation of the push button 34, such as (de)activating the radio module 12, switching off the multicolor light-emitting diode 22 or switching said diode into a particular state, or switching the MCI bus slave 10 into a particular operating mode, such as displaying the general operating state of the networked control system 20 (see below also). The multicolor light-emitting diode 22 can be integrated into the push button 34, as can the radio module 12.

As shown in FIG. 1, the MCI bus slave 10 is connected to the bus 19 of a bus system 18 by means of the bus interface 16. Furthermore, a central control unit 24 operated as a bus master, for example an easy800 control relay from Eaton Industries GmbH, a circuit breaker 26, a motor starter 28 and a motor protection switch 30 are connected to the bus 19. The apparatuses 26, 28 and 30 are each operated in the bus system 18 as bus slaves, as is the apparatus 10, as a result of which they can track the data traffic of the bus system 18 and receive commands addressed to them from the central control unit 24, as well as being able to transmit data on request from the central control unit 24.

As master, the central control unit 24 can activate any station which is operated as a slave and is connected to the bus system 18, for example in order to retrieve the operating states of the circuit breaker 26, of the motor starter 28 and of the motor protection switch 30. If a critical operating state is indicated, for example if the motor protection switch is reporting an overload tripping, the MCI bus slave 10 can indicate this state via the multicolor light-emitting diode 22 by the slave 10 receiving corresponding alarm indication data of the motor protection switch 30 via the bus 19. Such an indication can also be initiated by the central control unit 24 by said unit addressing a corresponding command to the MCI bus slave 10. The critical operating state of the motor protection switch 30 is then indicated by the controller 32 activating the multicolor light-emitting diode 22 such that corresponding color and/or flashing patterns are generated by the light-emitting diode 22, which then indicate this critical operating state.

The controller 32 can also transmit the alarm indication data 31 via the radio module 12 to the tablet PC 14, which can analyze and display the data using an appropriate program.

As a result of the increased possibilities of information presentation using the MCI bus slave 10, not only can critical operating states be indicated but also status data of the central control unit 24 and the other stations 26, 28 and 30 can be received via the bus interface 16, processed by the controller 32 and transmitted via the radio module 12 to the tablet PC 14, which can display this data using an appropriate program. For this purpose, the controller 32 can, for example, monitor the data transfer on the bus 19 by means of the bus interface 16 and process received status data from other stations and transmit it to the tablet PC 14 for display. For example, current value data 29 of the motor starter 28 can be received via the bus interface 16, processed by the controller 32 and transmitted via the radio module 12 to the tablet PC 14 to be displayed.

Furthermore, commands from the tablet PC 14 can be transmitted to the MCI bus slave 10. The commands received via the radio module 12 of the MCI bus slave 10 can be processed directly by the controller 32 and, for example, serve to configure the MCI bus slave 10, for example for configuring the multicolor light-emitting diode 22 via the controller 32, and/or the received commands can be transmitted by the controller 32 via the bus interface 16 and the bus 19 of the bus system 18 to the bus master 24, which processes them, for example sets and/or changes the operating parameters of the stations 26, 28, 30.

By means of a corresponding configuration of the controller 32, the MCI bus slave 10 can also be set up such that it displays the general operating state of the networked control system 20 via the multicolor light-emitting diode 22 and/or the radio module 12 and the tablet PC 14, as a result of which, for example, a visual display on the central control unit is no longer needed. As general operating states, “PLC run”, “PLC stop”, “PLC system error” and “PLC maintenance” can, for example, be displayed if the networked control system is a PLC (programmable logic controller).

The MCI bus slave 10 can also be configured as a Modbus® RTU slave or CANopen® slave and have corresponding data objects, which can be described by corresponding programming of a PLC of the networked control system 20 and transmitted via the radio module 12 by the MCI bus slave 10 to the tablet PC 14 to be displayed.

In a further embodiment, the MCI bus slave 10 can be operated as a client of a radio network and in particular, be connected to a radio access point of a router of a data network for this purpose. As a result, access by accordingly configured clients of the data network to the MCI bus slave 10 is allowed in principle, and so even a client which is spatially very remote from the MCI bus slave 10, such as a monitoring computer in a control console connected to the data network, can receive and display data from the stations 26, 28, 30 via the MCI bus slave 10 and if applicable, also transmit commands to these stations via the MCI bus slave 10 and the bus master 24. In this case, not only is a point-to-point communication possible, such as between the tablet PC 14 and the MCI bus slave 10, but so too is a multipoint-to-point communication of any client of the data network with the MCI bus slave 10, as a result of which the activity radius can be significantly increased. In FIG. 1, this possibility is shown by the connection between the radio module 12 of the MCI bus slave 10 and the data network 36.

As a result of the present invention, a display apparatus provided for indicating operating states of other devices is developed such that the limited indication possibilities of an MCI hitherto implemented by a multicolor light-emitting diode can be increased in that a device, such as a mobile computer, configured for communicating with the display apparatus can be used for displaying additional information. For this purpose, the display apparatus is configured according to the invention for use in particular in a networked control system as a bus slave and is equipped with a wireless interface for transmitting additional information of the networked control system.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### REFERENCE NUMERALS

10 MCI bus slave

12 Radio module

14 Tablet PC

16 Wired bus interface

18 Bus system

19 Bus

20 Networked control system

22 Multicolor light-emitting diode

24 Central control unit (bus master)

26 Circuit breaker

28 Motor starter

29 Current value data of the motor starter 28

30 Motor protection switch

31 Alarm indication data of the motor protection switch 30

32 Controller

34 Push button

36 Data network

1. A display apparatus, comprising:
a wireless interface, which allows communication between the display apparatus and a device configured for communication with the display apparatus;
an interface to a bus system of a networked control system, the display apparatus being configured as a bus slave in the bus system;
a multicolor display element, configured to display an operating state of at least one station;
a controller, configured to control the multicolor display element and control the communication via the wireless interface and the bus system interface,
wherein the controller is configure to receive data from at least one station via a bus of the bus system, and
wherein the controller is configured to transmit the data via the wireless interface to the device configured for communication with the display apparatus.

2. (canceled)

3. The apparatus of claim 1, wherein the controller is configured to receive data from a control unit, configured as a bus master, of the networked control system via a bus of the bus system, and
wherein the controller is configured to transmit the data via the wireless interface to the device configured for communication with the display apparatus.

4. The apparatus of claim 1, comprising:
a manual activation element, connected to the controller, the manual activation element configured, when activated, to set a flag for the controller,
wherein the flag can be analyzed by a bus master and/or carries out programmed function.

5. The apparatus of claim 4, wherein the wireless interface is a radio module,
wherein the radio module is integrated into the activation element together with the multicolor display element.

6. The apparatus of claim 1, configured as a Modbus® RTU slave.

7. The apparatus of claim 6, wherein the controller is programmed such that the controller includes data objects, which can be described by corresponding programming of the networked control system via the bus system, and
wherein the controller is programmed such that the controller transfers described data objects via the wireless interface to a device configured for communication with the display apparatus.

8. A system, comprising:
the display apparatus of claim 1; and
a communication device including a wireless interface including a processor that can be programmed such that the communication device can communicate via the wireless interface with the display apparatus and receive data from the display apparatus and display the data on a screen.

9. The apparatus of claim 1, configured as a CANopen® slave.
